(19) United States
(12) Patent Application Publication
(10) Pub. No.: US 2008/0071392 A1
(43) Pub. Date: Mar. 20, 2008

(54) Building safety system and method

(75) Inventors: Michael G. Brown, Tacoma, WA (US); Thomas Lee Brubaker, Newcastle, WA (US); Tammy E. Atteberry, Vashon, WA (US)

Correspondence Address: DLA PIPER US LLP, 2000 UNIVERSITY AVENUE, E. PALO ALTO, CA, 94303-2248, US

(73) Assignee: Prepared Response, Inc.

(21) Appl. No.: 11/524,631

(22) Filed: Sep. 20, 2006

(51) Int. Cl. G05B 11/01

(52) U.S. Cl. 700/23

(57) ABSTRACT

A building safety system and method are provided that permits occupants of a building to access building safety information. The system also permits the building owner/management company to monitor and administer building safety training.

### FIELD OF THE INVENTION

The invention relates generally to a system and method for building safety maintenance.

### BACKGROUND OF THE INVENTION

It is desirable to provide a computer-based system and method for building safety that permits and it is to this end that the present invention is directed.

### BRIEF DESCRIPTION OF THE DRAWINGS

FIG. 1 illustrates an example of a web-based embodiment a building safety system;

FIG. 2 illustrates an example of a database schema for the building safety system shown in FIG. 1;

FIGS. 3-27 illustrate more details of the database tables shown in the database schema shown in FIG. 2;

FIG. 28 illustrates an example of a procedures user interface for an example of the building safety system;

FIG. 29 illustrates an example of a building safety procedure user interface for an example of the building safety system;

FIG. 30 illustrates an example of a building profile set-up user interface for an example of the building safety system;

FIG. 31 illustrates another example of a building profile set-up user interface for an example of the building safety system;

FIG. 32 illustrates an example of a building management user interface for an example of the building safety system;

FIG. 33 illustrates an example of a building training events user interface for an example of the building safety system;

FIG. 34 illustrates an example of an account configuration user interface for an example of the building safety system; and

FIG. 35 illustrates an example of a building safety procedures user interface for an example of the building safety system.

### DETAILED DESCRIPTION OF AN EMBODIMENT

The invention is particularly applicable to a web-based system and it is in this context that the invention will be described. It will be appreciated, however, that the system and method has greater utility since the system and/or method can be implemented with a variety of different computer systems and architectures and the invention is not limited to any particular implementation of the system.

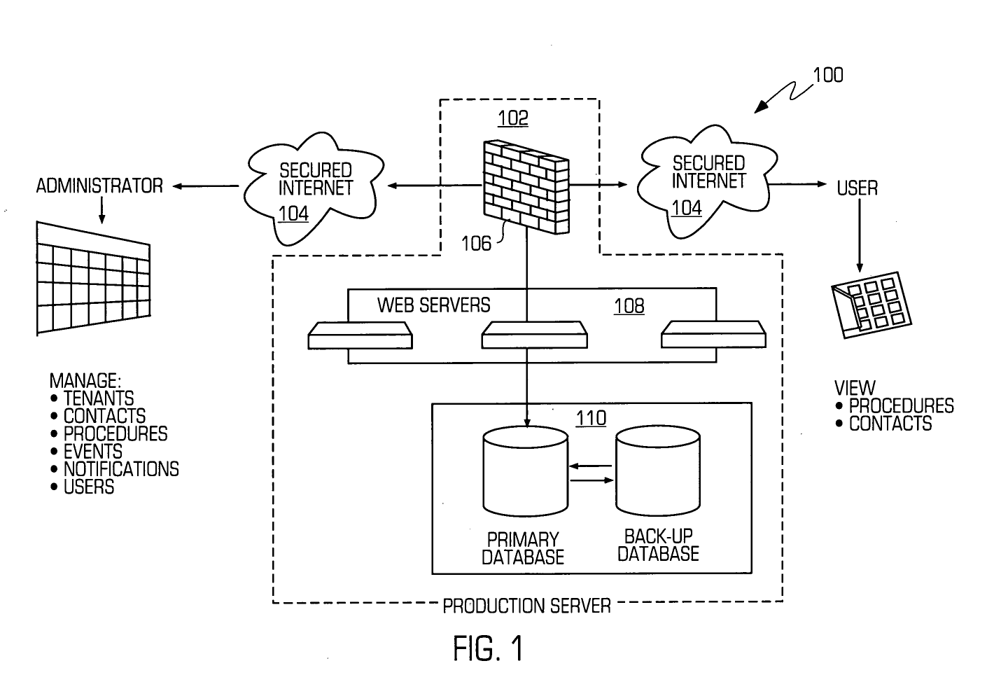

FIG. 1 illustrates an example of a web-based embodiment a building safety system 100 wherein the system is implemented as a Internet based (client-server) system using a database shown in FIG. 1. However, the building safety system is not limited to the particular implementation shown in FIG. 1 as it can be implemented differently as would be understood by those skilled in the art. The system 100 may include a production unit 102, such as a server computer, that is coupled through a communications link 104, such as the Secured Internet, a wireless network or any other communications network, to one or more users and one or more administrators. The users and administrators may use typical computing devices, such as PDAs, laptop computers, tablet computers, palmtop computers, handheld computers, wireless email devices, mobile computing devices, cellular phones, mobile phones or any device with sufficient processing power, memory and connectivity to access the production unit 102 over the communications link, to access the production unit 102. The one or more users may access the system in order to view building safety procedures or building safety contacts. The one or more administrators may manage the building safety, implemented by the building safety system, that may include managing tenants of the building, managing building safety contacts, managing building safety procedures, managing building safety training events and building safety events, managing building safety notifications and managing users of the building safety management system.

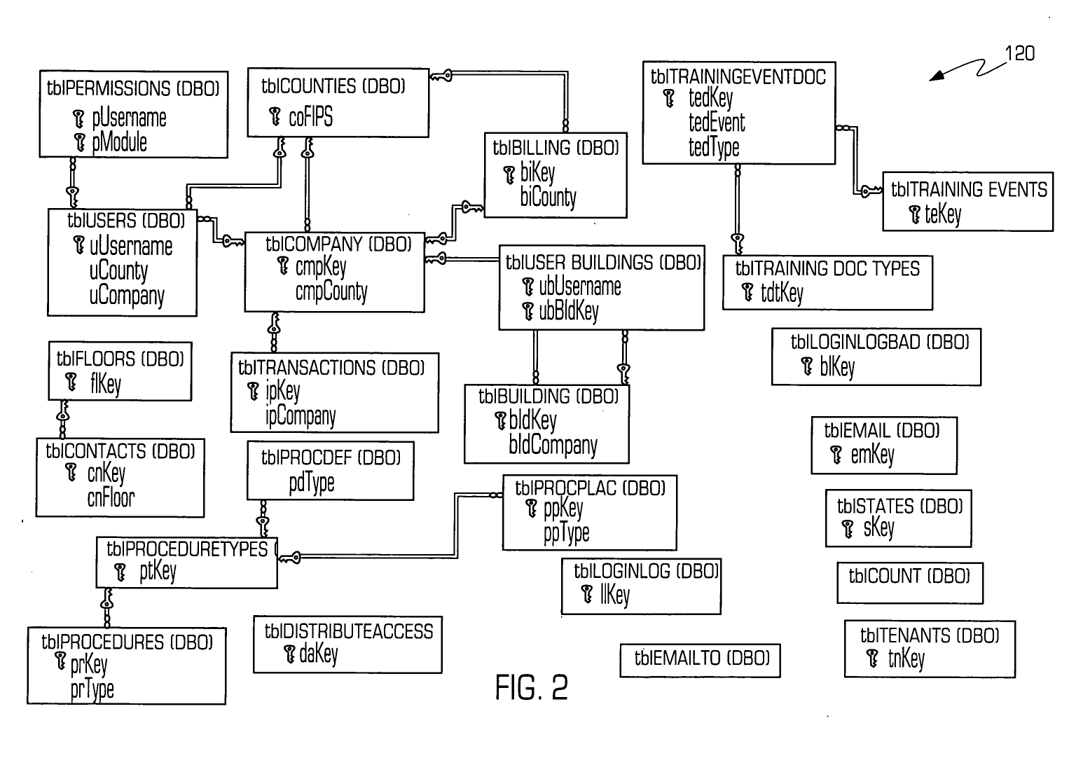

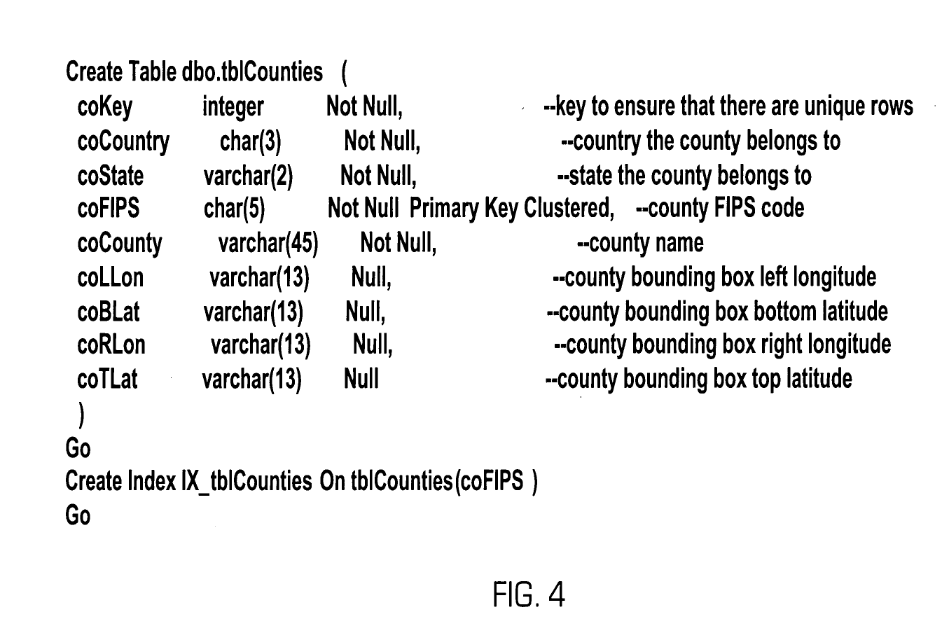

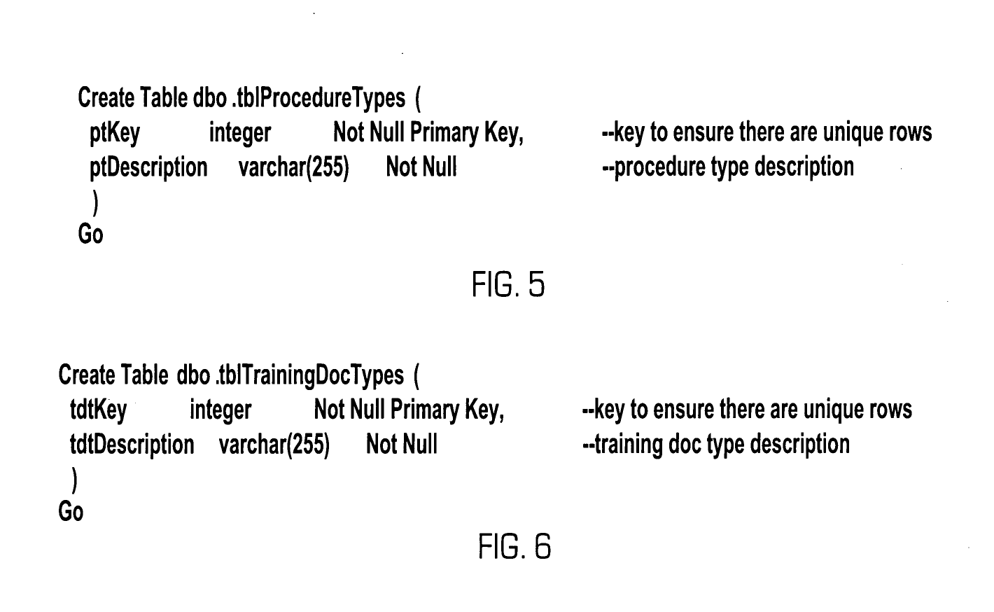

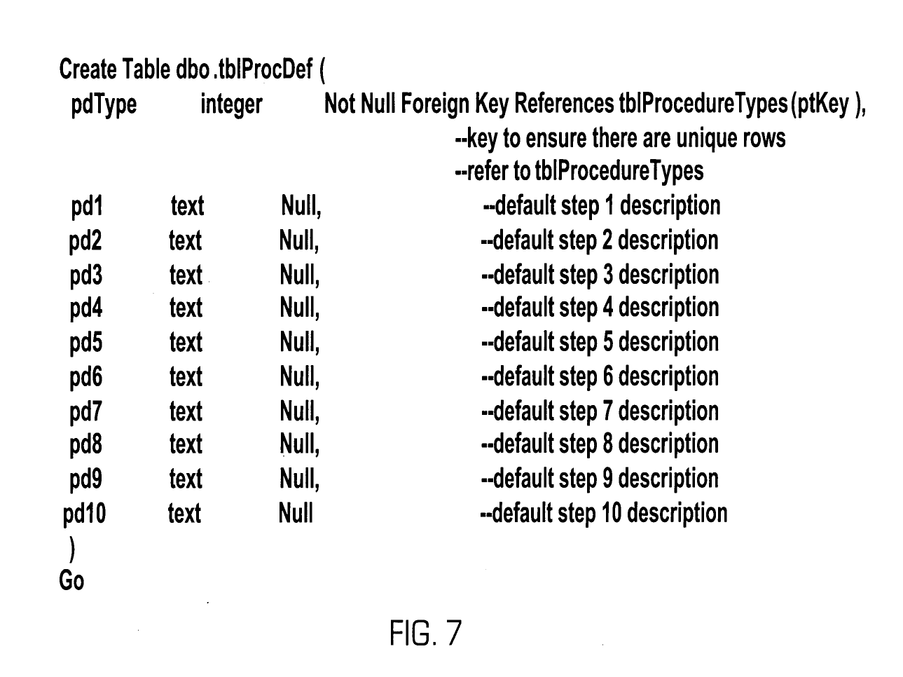

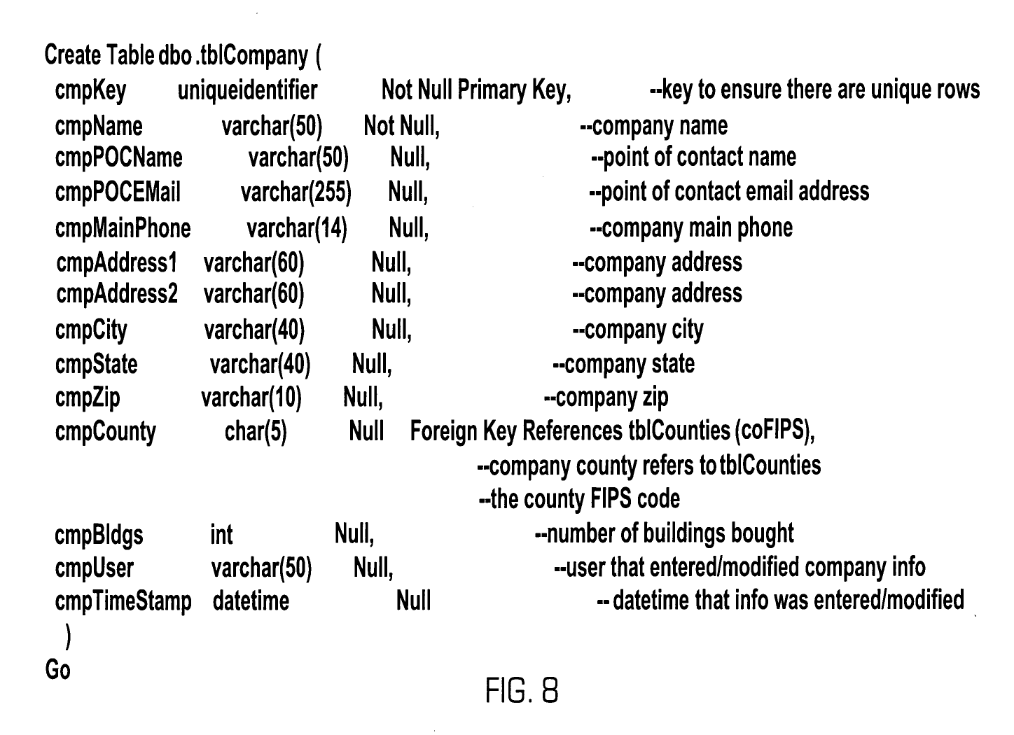

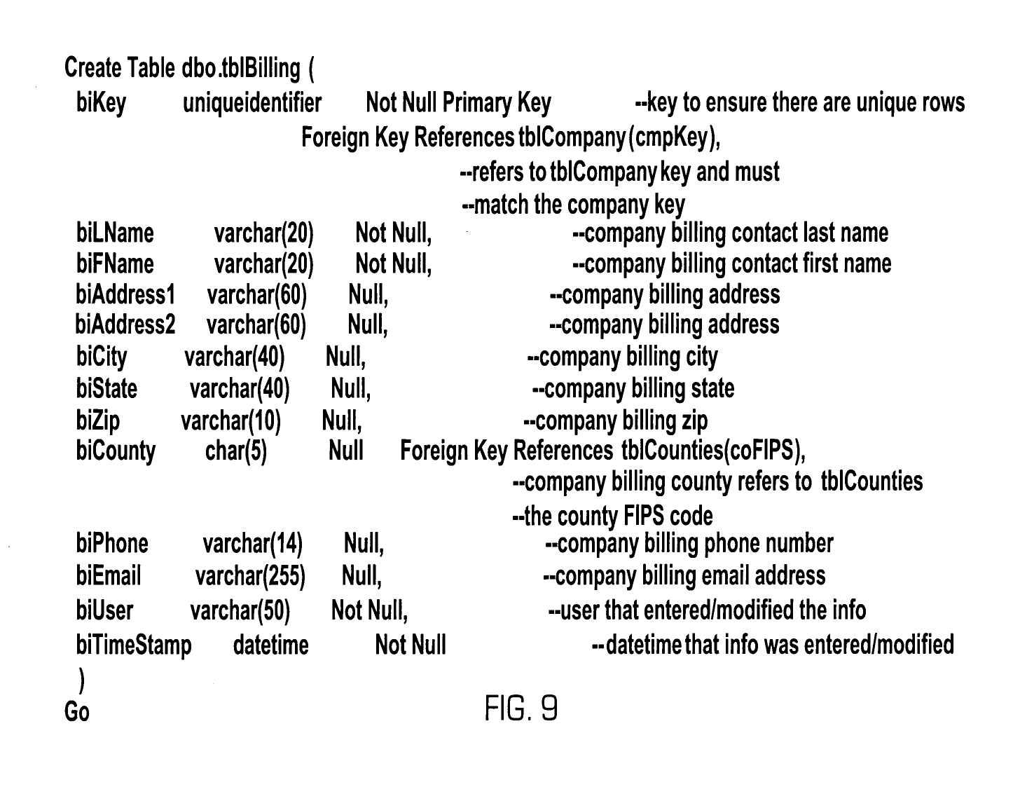

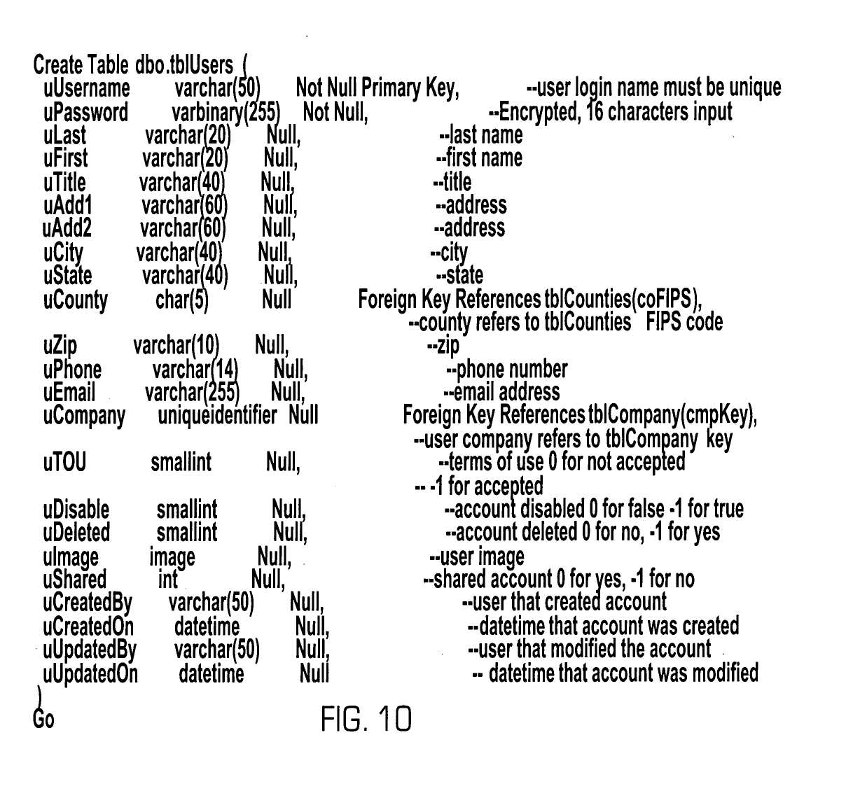

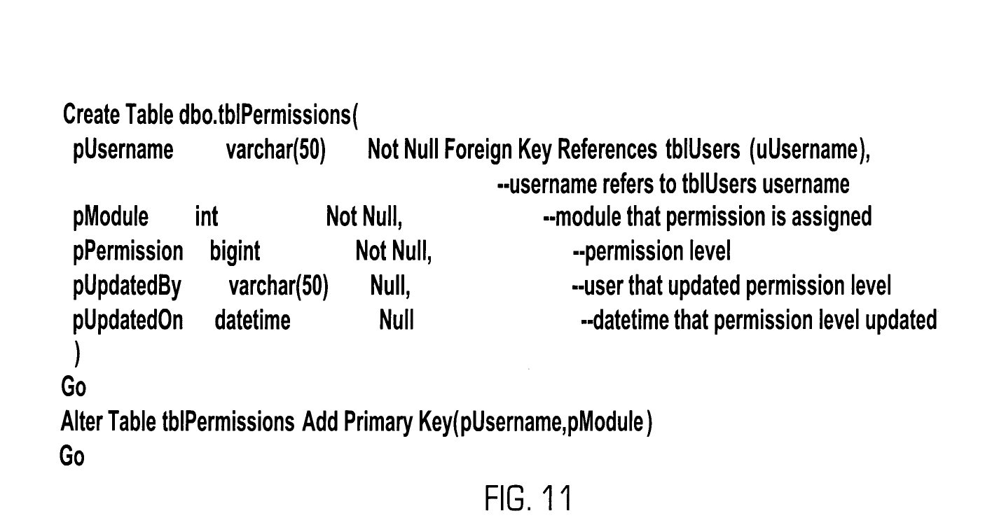

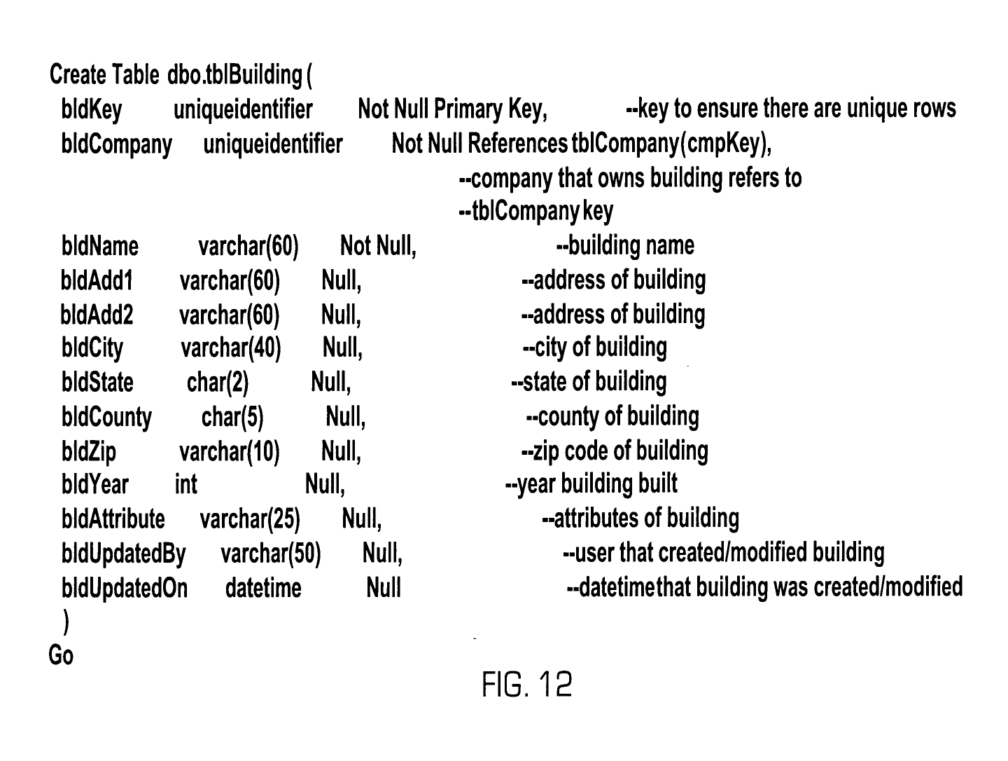

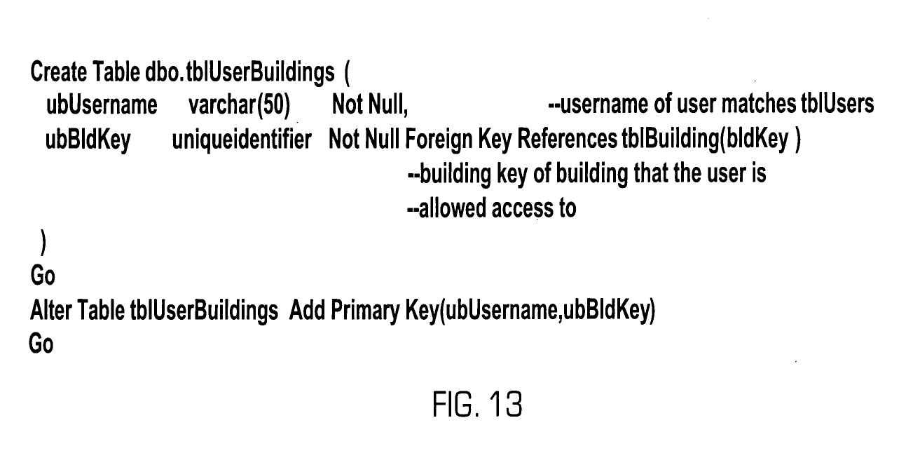

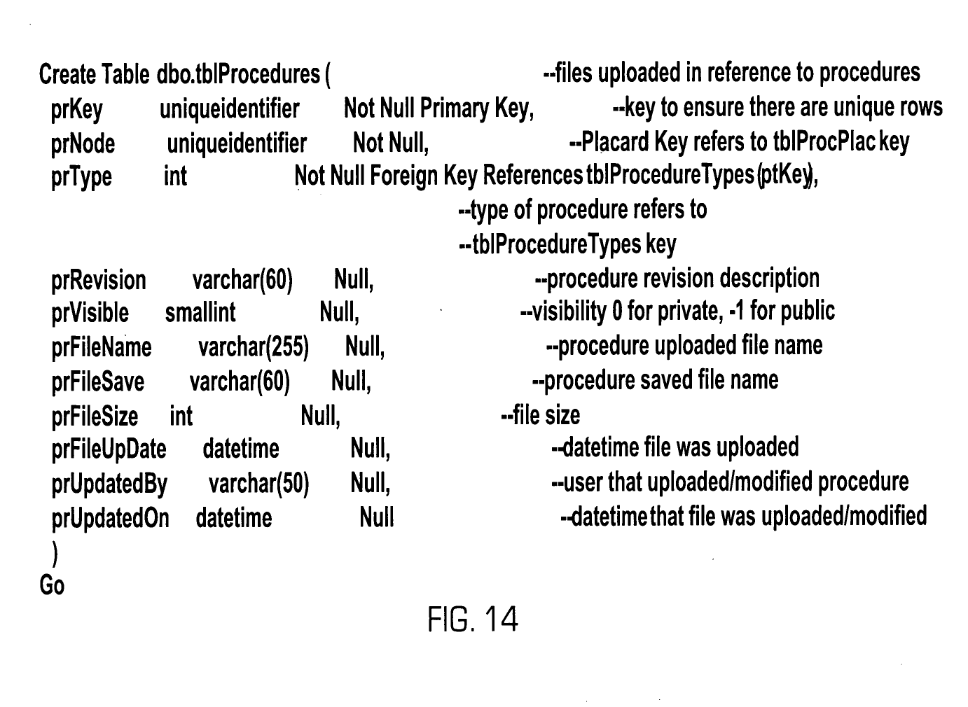

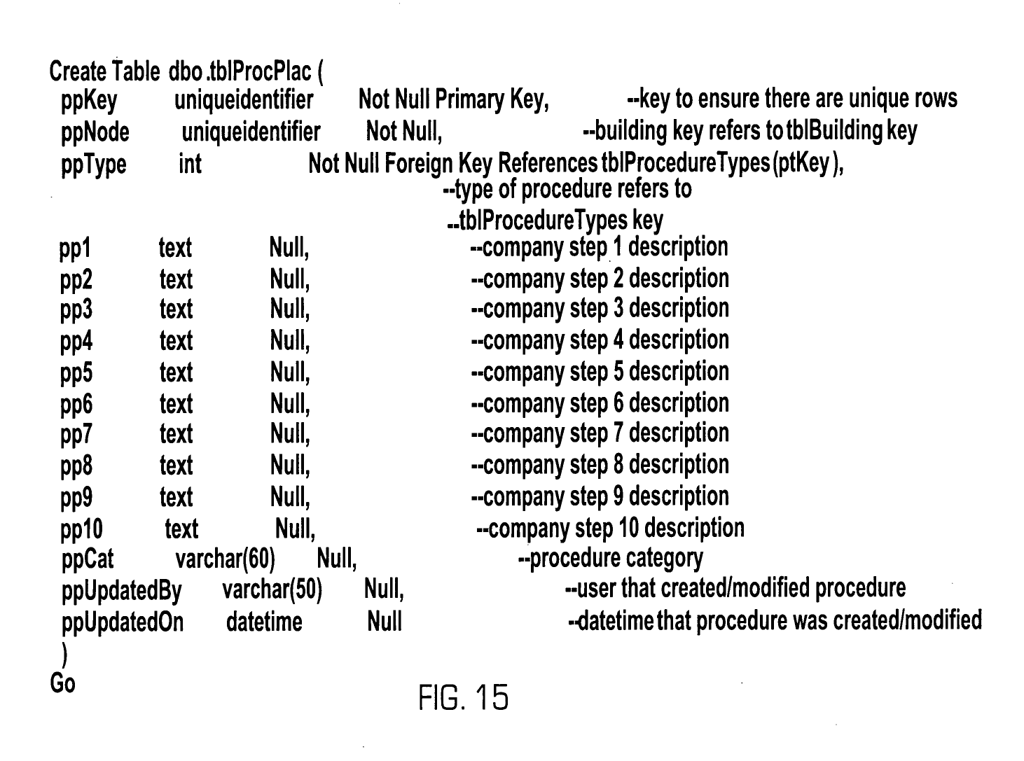

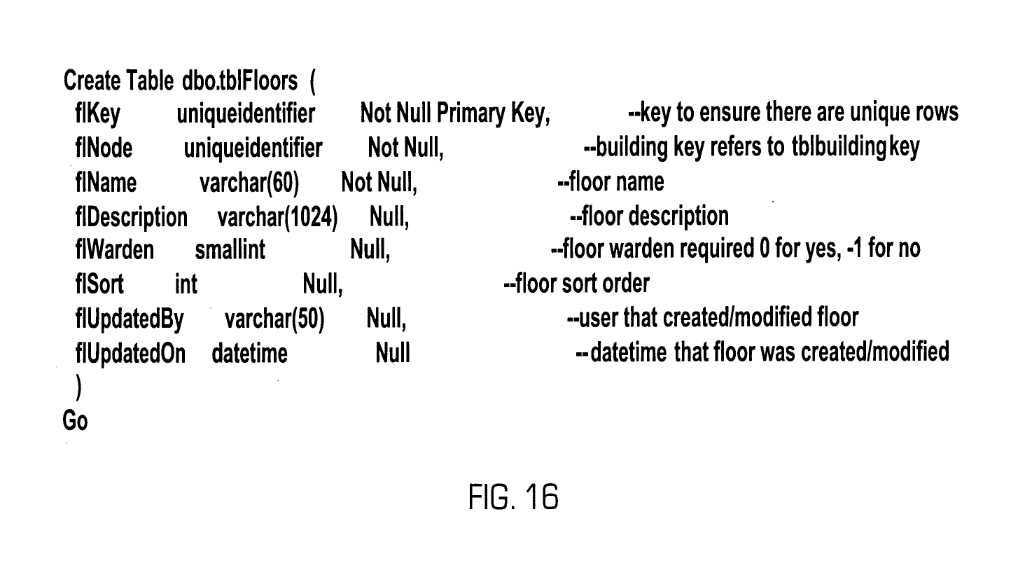

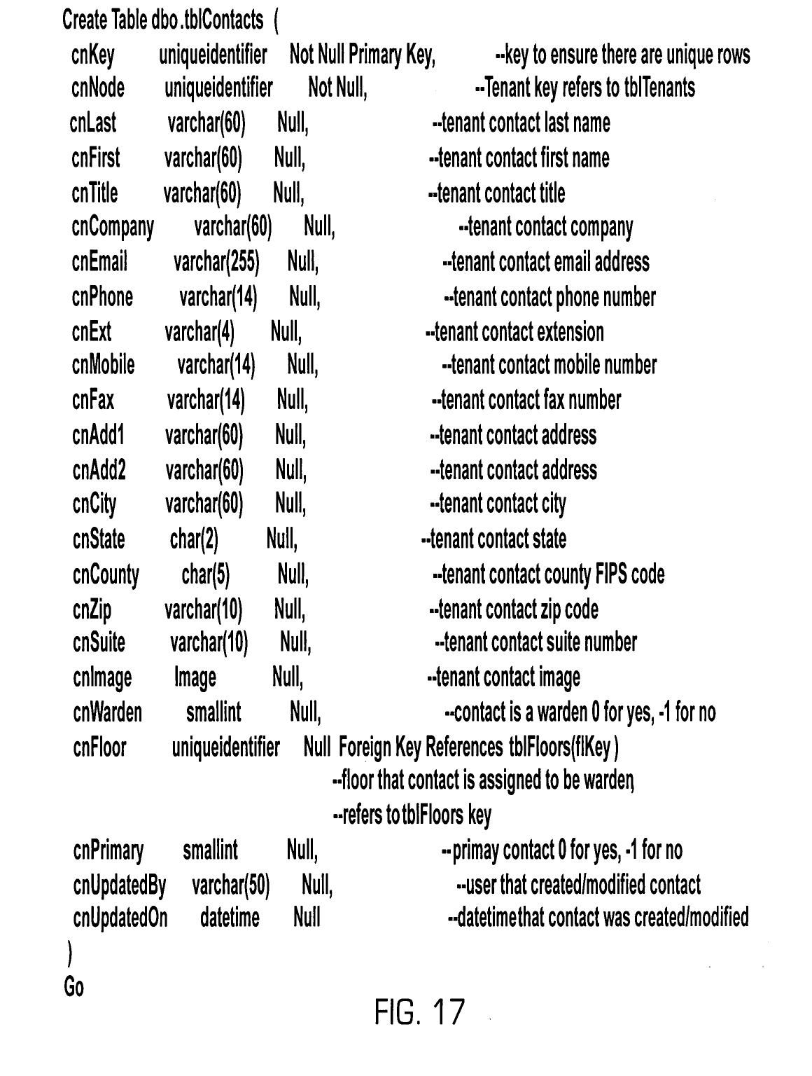

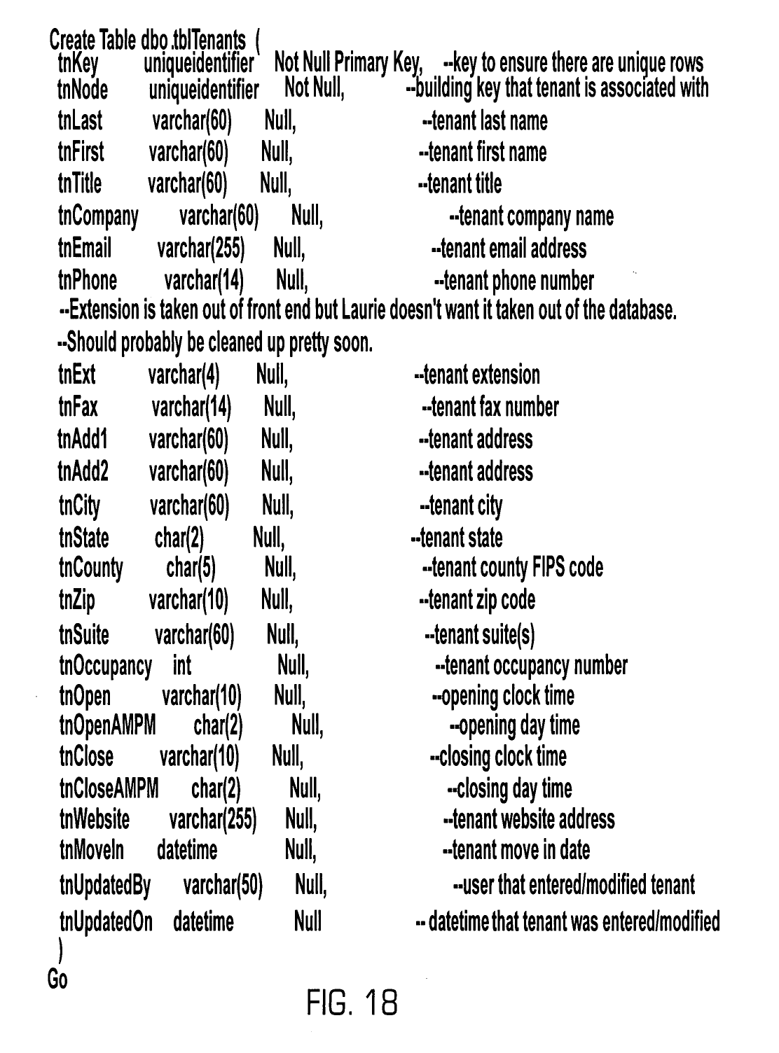

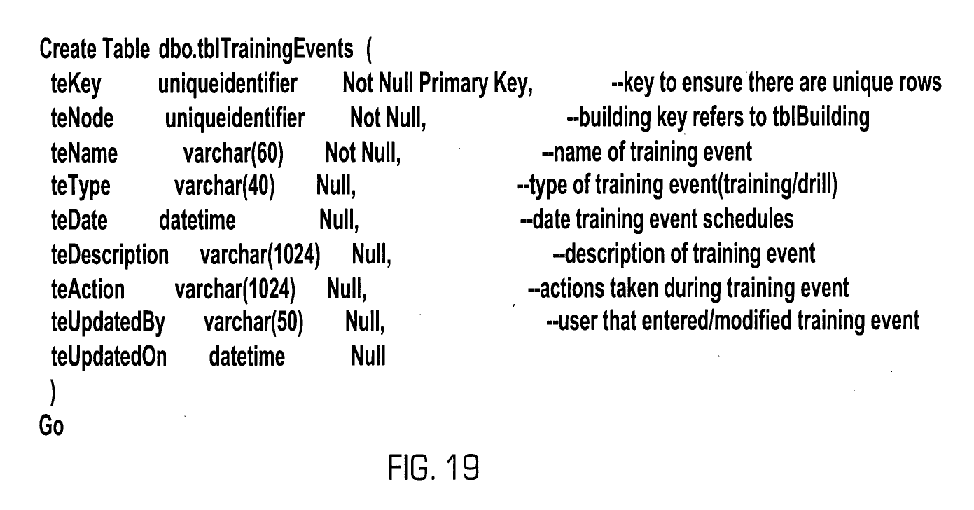

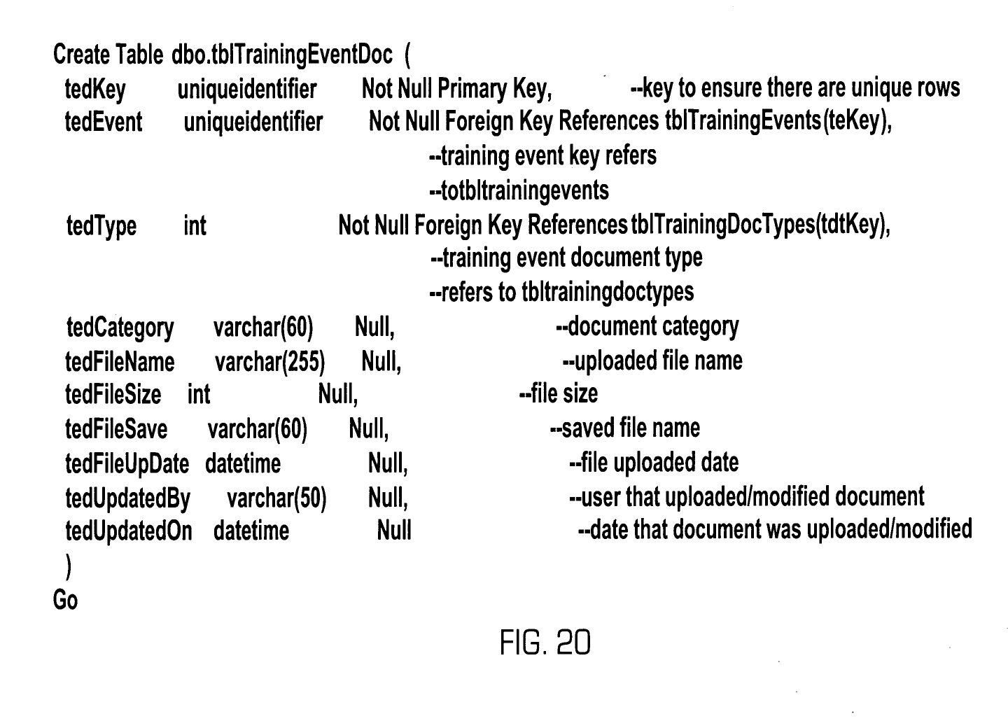

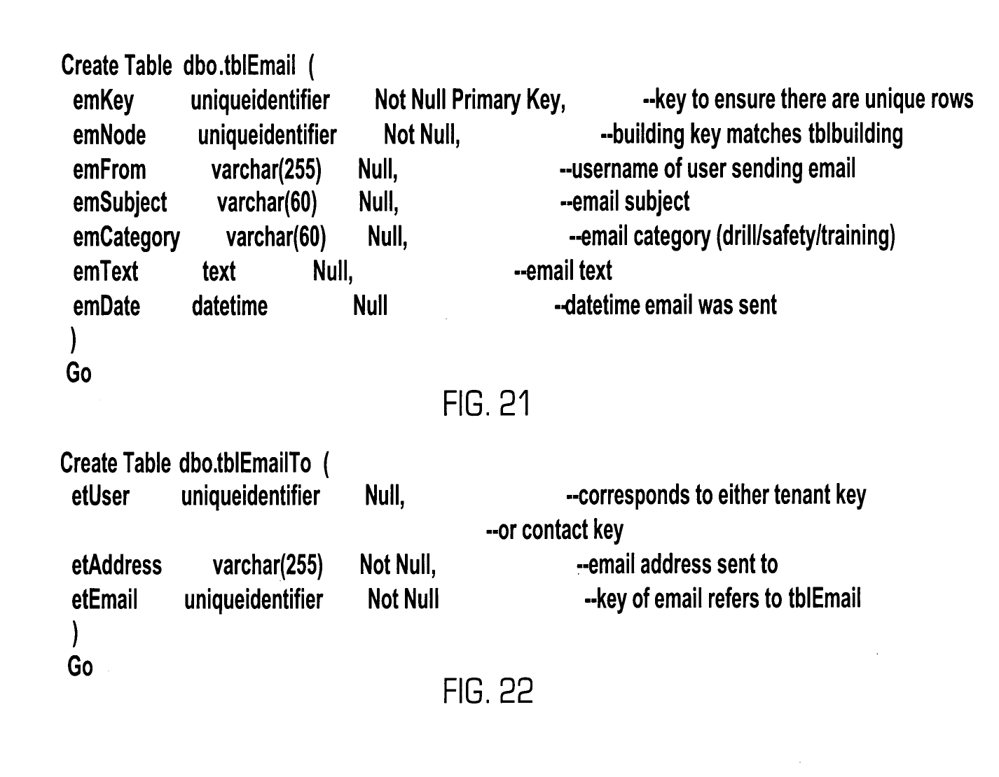

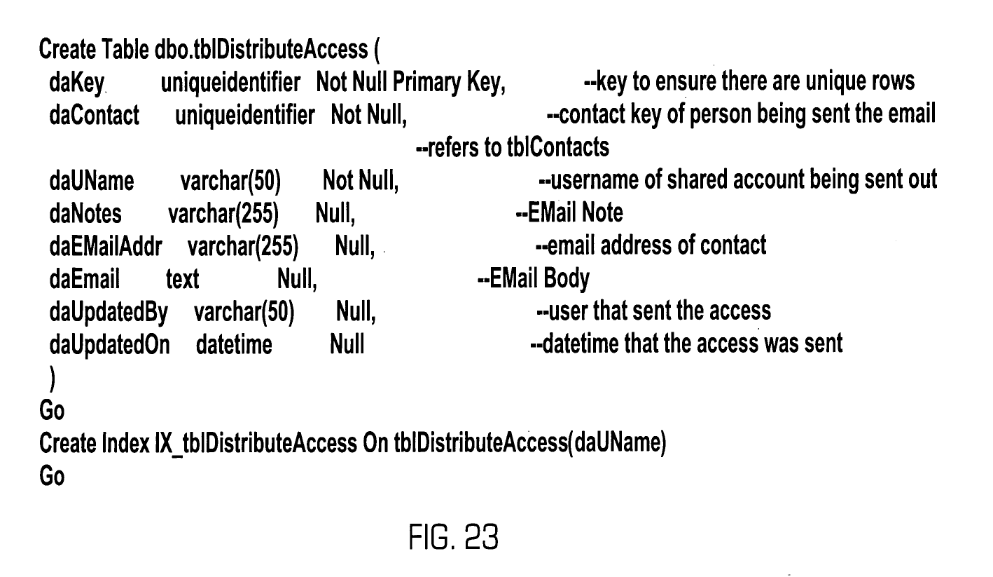

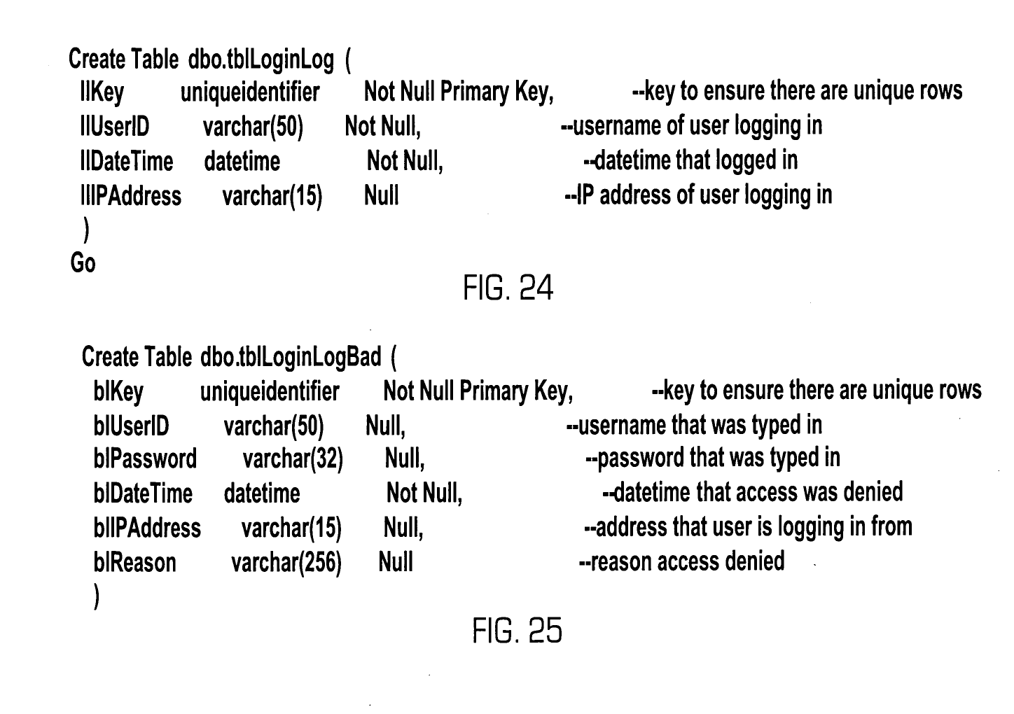

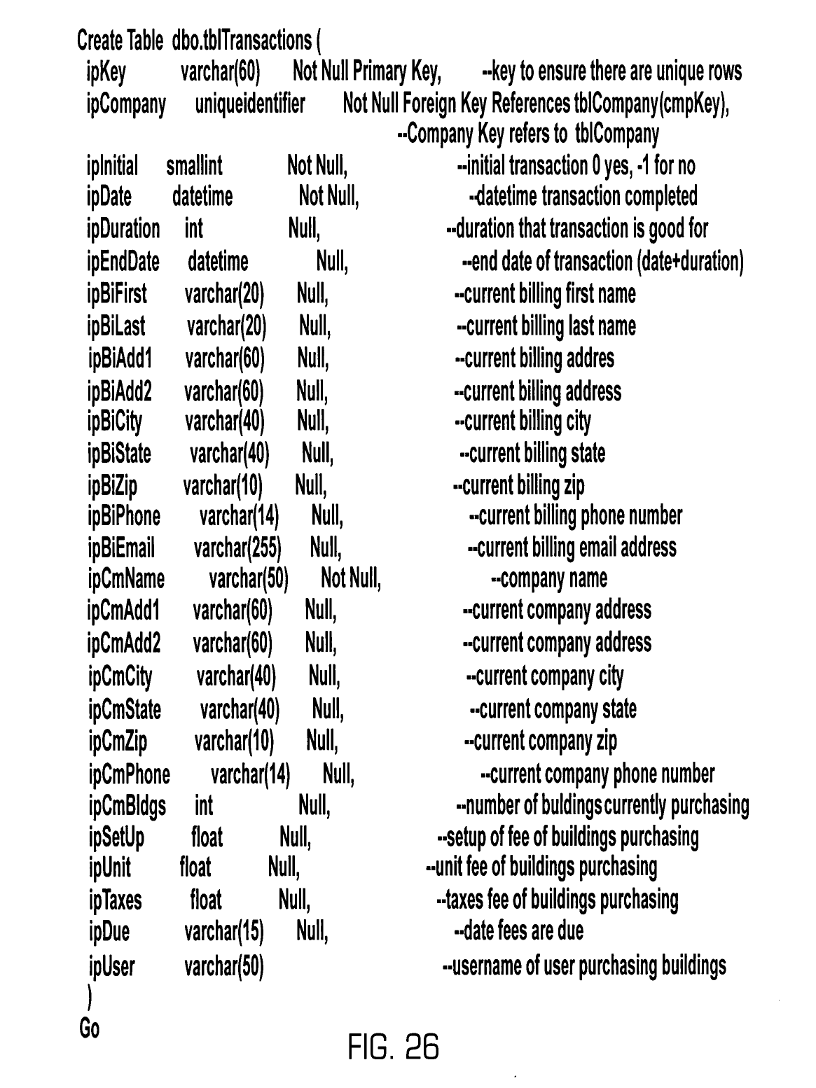

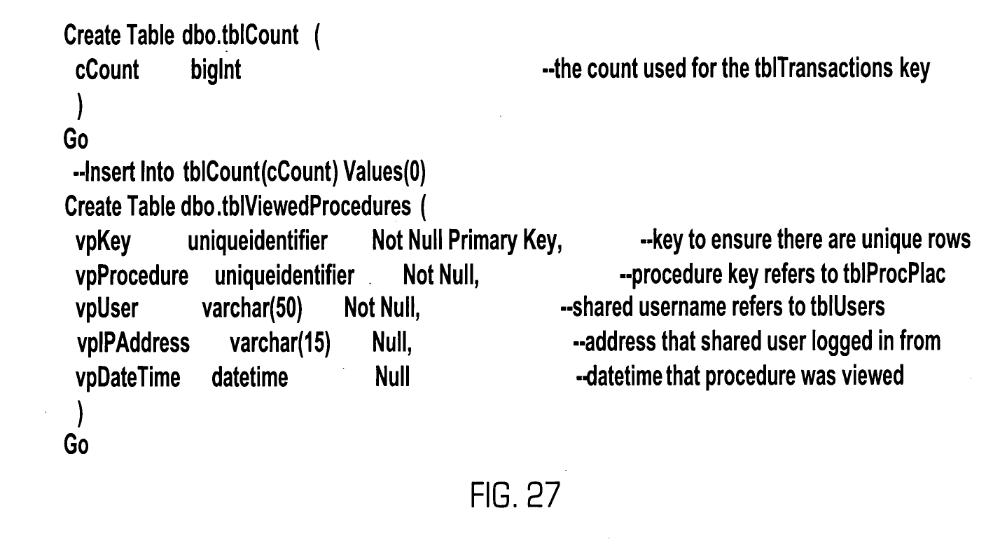

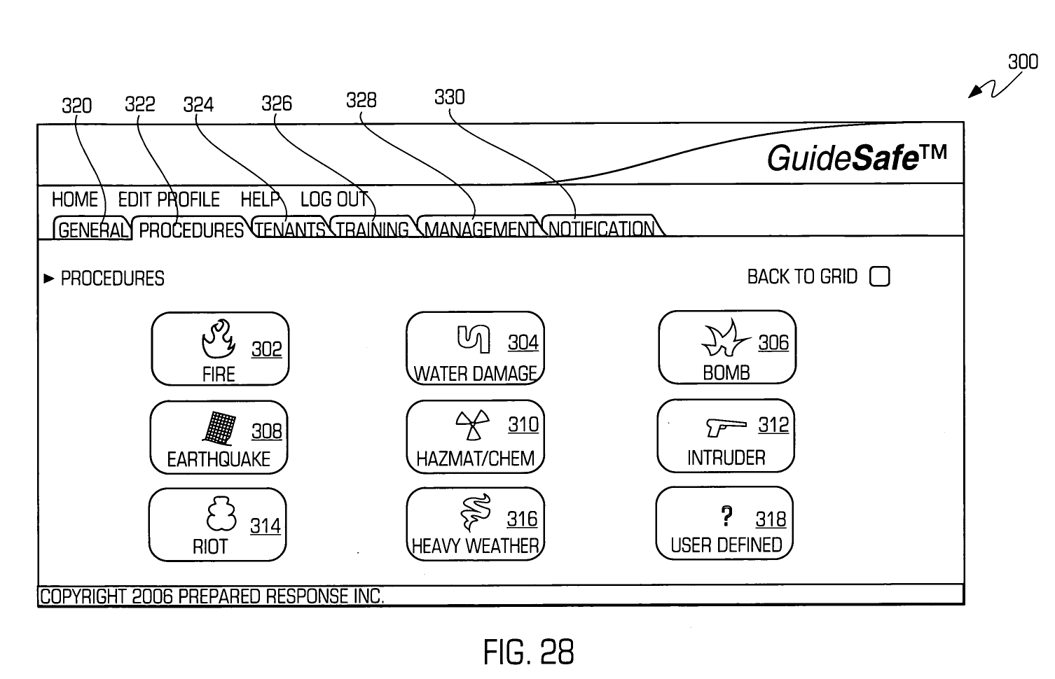

The production unit 102 may include a security mechanism 106, such as a well known firewall, that secures the communications links and maintains the security of the production unit and one or more web devices 108, such as well known web servers, that are used to balance the load of the building safety system. The production unit 102 further comprises a data storage unit 110, such as a primary database and a back-up database as shown, that stores the data, such as user data and building safety content, used by the building safety system to implement the functions and operations of the building safety system. The details of the data used by the building safety system is described in more detail below with reference to FIGS. 2-27. The functions and processes implemented by the building safety system are described in more detail below with reference to FIGS. 28-35. The building safety system may include one or more functional units wherein each functional unit comprises one or more lines of computer code that implement the processes/functions for the particular unit. In one embodiment, the building safety management system may include a procedures unit that stores, displays and manages the building safety procedures as described below, a tenants unit that displays the tenant information and manages the tenants as described below, a training unit that stores, displays and manages the building safety management training as described below, a management unit that manages the user and administrators and performs other management and administrator processes as described below, a notification unit that stores, implements and manages the notifications generated by the building safety management system and an access unit that manages the access to the data contained in the building safety management system as described below.

The building safety management system 100 shown in FIG. 1 provides occupants of a building with safety instructions and procedures to be used in case of emergency. The system can also be used by building managers and administrators for tracking tenants, compliance with fire codes and/or storing information for each business' or tenant's point of contact. The building safety management content, such as building safety procedures, safety training and the like, and access to the content can be administered on-line by one or several account managers (administrators) in a secure manner. The building tenants can access the information stored on the system in order to obtain guidance on how to handle or act in an emergency. Additional general training information could be conveyed to the tenants or building occupants by the building safety management may include, but not limited to medical training (CPR video, first aid, etc), employee training (OSHA training, sexual harassment, equal opportunity, etc) and real-time information (news, weather, crime statistics, etc). The building tenants can access training information in various formats, such as .mpeg, .doc, .ppt and a variety of other file formats. Using this on-line application, building owners and managers can, in part, satisfy certain training and posting requirements embodied in local law. Further, the building manager can document the conduct of training including the subject matter, the training material used, those present and follow-up steps.

The building safety management system permits a landlord/management company to have an account. With the account, one or many buildings can be administered each with its own unique set of content and tenants. The information captured and stored in the data storage unit for each building may include the building name, the building address, city, state, zip code, geographic location (e.g. latitude, longitude, elevation), the year that the building was built, and the current occupancy of the building. The information can be indexed and displayed by any of these characteristics of the building.

The building safety management system also permits a building owner/management company to estimate damage to a building due to an natural disaster, such as an earthquake. For an earthquake, using reference data and data collected in the system including the building location, year built, number of floors, occupancy, and cross referencing local soil type(s) and earthquake magnitude and duration, the maximum vertical and horizontal accelerations of the earthquake can be estimated by interpolating within a table of expected and previously experienced damage for the building having that construction type. Using the expected building occupancy, deaths and injuries for the building can be estimated. Overall urban damage can be estimated based on building density and using the building safety management system as a sampling.

For each building, the building safety management system provides a default set of generalized emergency procedures suitable for most buildings. The safety procedures may include, but are not limited to: bomb threat, earthquakes, fire, flooding, tornado, ice storm, violent intruder, riot, power outage, spill of hazardous material, and medical emergencies. Using the building safety management system, administrators can modify the procedures and add other procedures as desired. The pre-defined procedures are assigned a standardized icon within a user interface for easy identification. The procedures are consistently presented with a large red numeral to demark each step thus enhancing a user's ability to understand and implement emergency action. In an emergency, users can either reference the procedures locally on their hard drive, on the Internet using the pre-defined buttons, or in printed form.

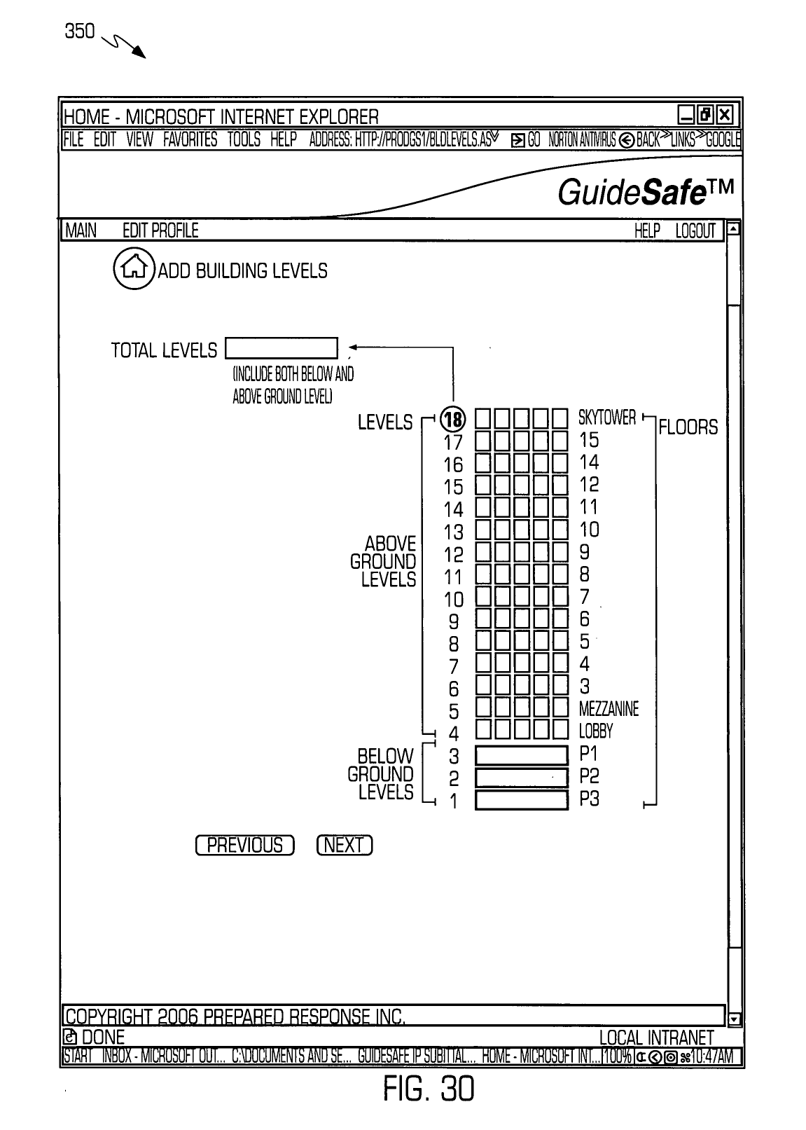

The building safety management system also provides a standardized method to manage the floors of a building since there is general confusion and inconsistency regarding how to count, number and manage floors of the building. In particular, in some cases floor 13 exists (labeled) in other cases, the floor numbering progresses 10, 11, 12, 14, 15 (thus skipping floor 13). In addition, mezzanines, equipment floors and spaces designated for maintenance are sometime counted as floors, sometimes not. Similarly, lobby and grand reception areas are often difficult to name (floor 1, main floor, lobby, etc). Underground levels also pose a challenge since it is not clear whether or not they are counted as a floor or a basement. The building safety management system introduces a generalized “level” counting system that accounts for each elevation (full floor, a parking space, mezzanine, attic, lobby or other horizontal level) as shown and described in more detail in FIG. 30. By first counting the levels, then assigning names to the level, we can account for each elevation while leaving sufficient latitude for custom names.

The building safety management system also provides the specification of fire code requirements. In particular, the floors within a building may require the presence of designated Floor Wardens for the safe evacuation of occupants during an emergency. In combination with the generalized floor management strategy, each level can be designated as one requiring a Floor Warden. If a Floor Warden is required for each tenant on the floor, the building safety management system can automatically determine if the correct number of Floor Wardens have been assigned and report that information for improved code compliance.

The building safety management system can be used to manage the tenants in a building and the contacts for a building. Thus, for each building, the manager can enter descriptive data (name, address, occupancy, business hours, web site, etc) for one or many tenants. The contacts associated with tenants can also be entered such that for each tenant, there is a list of contacts. Each contact contains descriptive data such as the nature of the contact (business interface, Floor Warden, etc). Contacts can be further classified as a Floor Warden which may be required for compliance to fire code.

The building safety management system may also be used to manage training events. In particular, for one or many training events (for each building), the administrator can record the conduct of the event, event type (drill, training, etc), date, note follow-up actions and associated documents such as attendance reports, training material, training videos. Building occupants may be permitted to view the training content depending on their level of permission.

The building safety management system also provides user management functions. In the system, there are two types of users that includes building occupants and administrators. The building occupants can log into the application to view procedures and/or training material for a specific building depending on their level of access. The administrative users are managed in two general ways: building assignment and permissions. An administrative user may be assigned access to one or many buildings. The content associated with the set of one or many buildings assigned to an administrator can be modified using a series of permissions that control a variety of actions including but not limited to such as sending email notifications, editing and managing procedures or training material, editing building information, creating an economic transaction, and adding or deleting a building.

The building safety management system may store descriptive information about each building that may include one or many physical or operational characteristics useful in the management of emergencies, the conduct of daily business, or the inventory of property, plant or equipment. The building data may include, but is not limited to: floor plans with or without emergency features annotated (such as emergency escape, fire hose, fire extinguisher, emergency defibrillator, first aid kit), internal images, list of equipment including serial numbers and operating characteristics, system diagrams, and operating procedures.

The building safety management system can store daily attendance rosters for building occupants by name and or by organization (where there are multiple organizations in the building). The system can also store a roster of those who might generally access the building for use as a check-off list in order to account for occupants in case of an emergency. The accountability system can also be used for employee time keeping where each employee logs in/out the system as they enter or depart the building. Alternatively, an administrator could log occupants in/out as a managerial function.

The building safety management system may also include a notification function that provides outgoing email notification(s) to selected contacts that are either stored in the database or entered on the fly. The outgoing emails are preserved in a searchable list thus allowing managers an auditable record of compliance notifications. The building safety management system may also manage drill scheduling and tracking wherein an administrator can send out drill notifications and track drills that are performed. The drill tracking may include who attended the training, time stamp/date of the drill and type of drill performed.

The building safety management system may also include an authorization mechanism that permits the system to provide different access levels for each different user of the system. For example, a building tenant may have limited access to view procedures and training materials. A Floor Warden may be able to access more information than a tenant and may also be able to modify certain information in the system. The one or more administrator(s) may manage the system and therefore have a different level of access to the information of the system and may be able to modify various information in the system. Now, the data schema for the building safety management system is described in more detail.

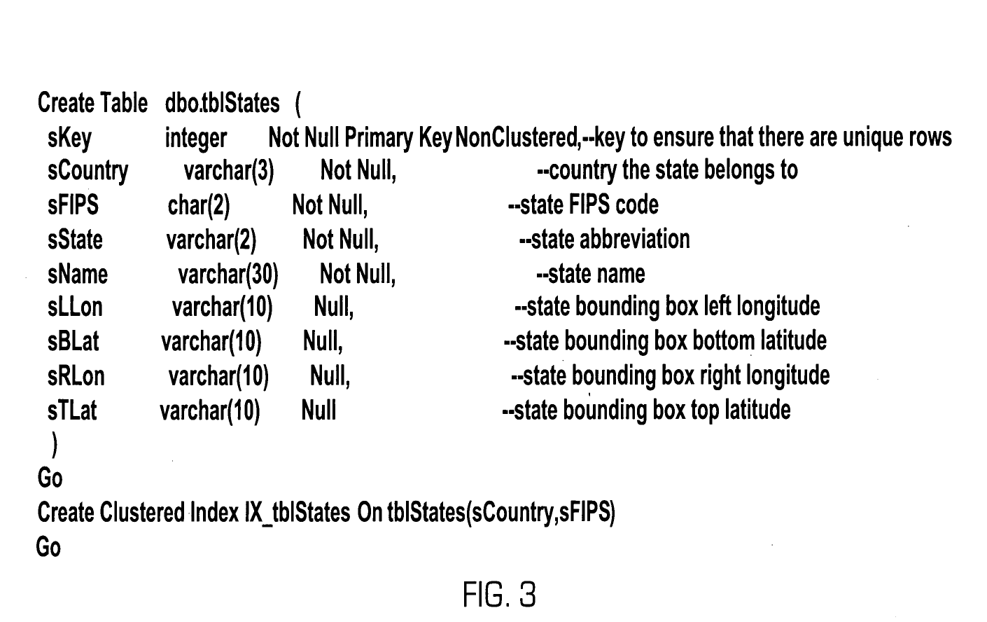

FIG. 2 illustrates an example of a database schema 120 for the building safety system shown in FIG. 1 wherein the data is stored in linked, relational tables. However, the data storage unit of the system may be implemented using other data storage techniques other than the linked tables shown in FIG. 2. Each table has a key that is used to relate each table to the other tables. The tables shown in FIG. 2 store the various data that is used by the building safety management system to manage the building and users and to implement the processes and functions of the building safety management system described above. The details of each table is shown in FIGS. 3-27. Now, examples of the user interface of the building safety management are described in more detail.

FIG. 28 illustrates an example of a procedures user interface 300 for an example of the building safety system. The procedures user interface 300 may include one or more buttons each with an icon that permits a user to easily identify each procedure and the user can select to view more details of the procedure by clicking on the button. The buttons may include a fire procedure button 302, a water damage procedure button 304, a bomb procedure button 306, an earthquake procedure button 308, a chemical/hazardous material procedure button 310, an intruder procedure button 312, a riot procedure button 314, a heavy weather procedure button 316 and a user defined procedure button 318. As shown, the user interface may also include a general tab/web page 320, a procedures page 322 shown in FIG. 28, a tenants page 324, a training page 326, a management page 328 and a notification page 330.

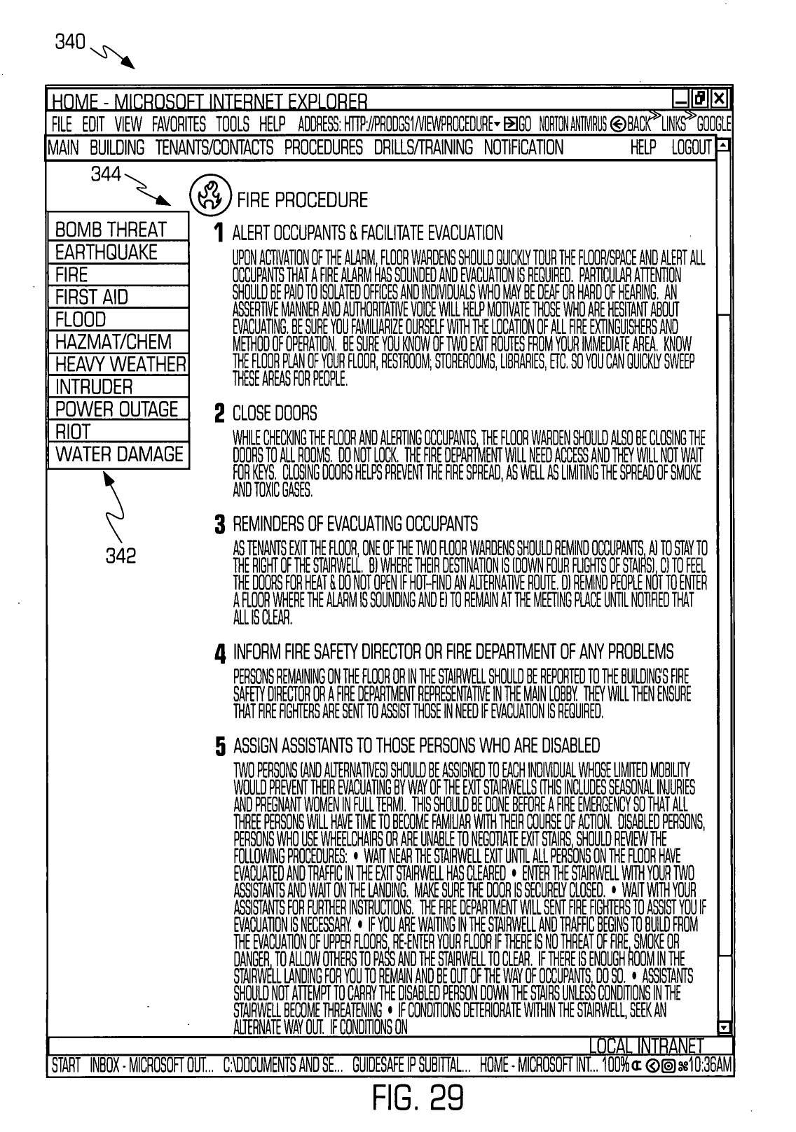

FIG. 29 illustrates an example of a building safety procedure user interface 340 for an example of the building safety system. The procedure user interface has a listing portion 342 of the procedures for this building that permits the user to select a particular procedure. The selected procedure, such as the fire procedure shown in FIG. 29, is displayed in a procedure display portion 344. As shown, the procedure provides various information to the user about the procedure.

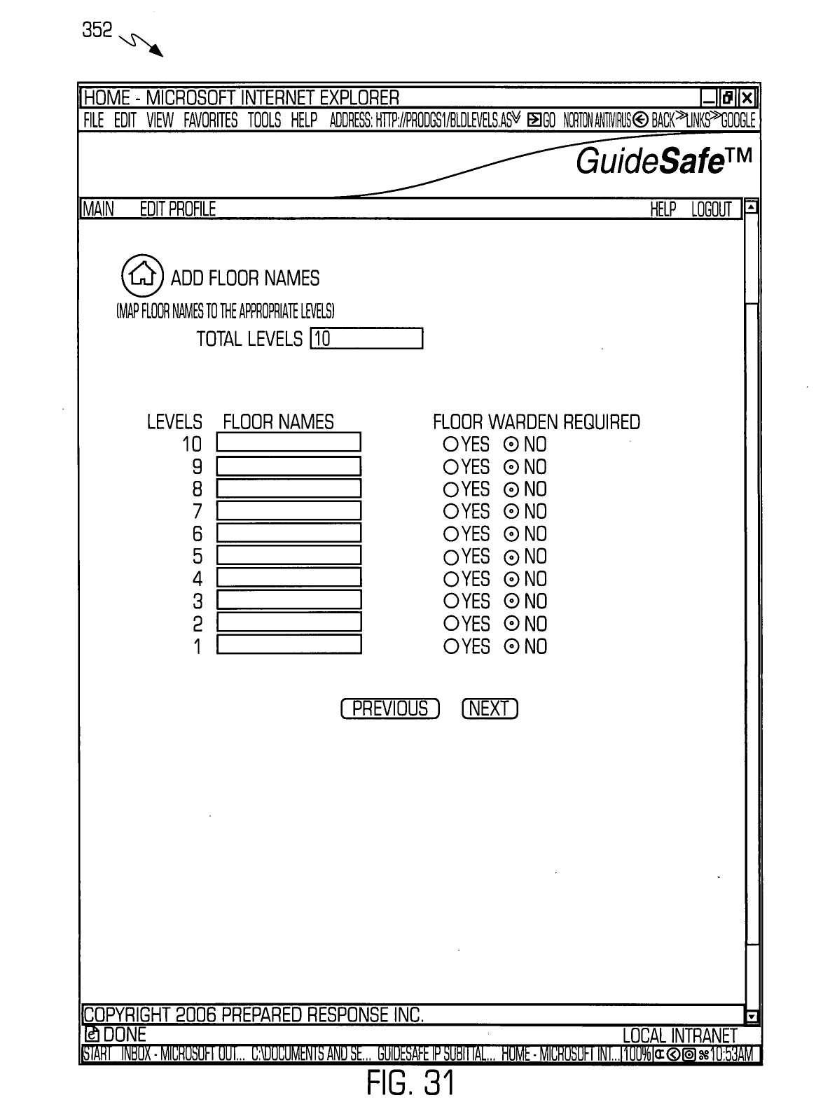

FIG. 30 illustrates an example of a building profile set-up user interface 350 for an example of the building safety system that permits, for each building, the floors of the building to be consistently identified and numbered within the building safety management system. As shown, the floors of the building may include any parking levels (and other floors beneath the ground), any lobby level(s), any mezzanine level(s) and any above ground levels. FIG. 31 illustrates another example of a building profile set-up user interface 352 for an example of the building safety system. Using this user interface, the building safety management system permits an administrator to name each floor and specify whether or not each floor requires a Floor Warden as was described above in more detail.

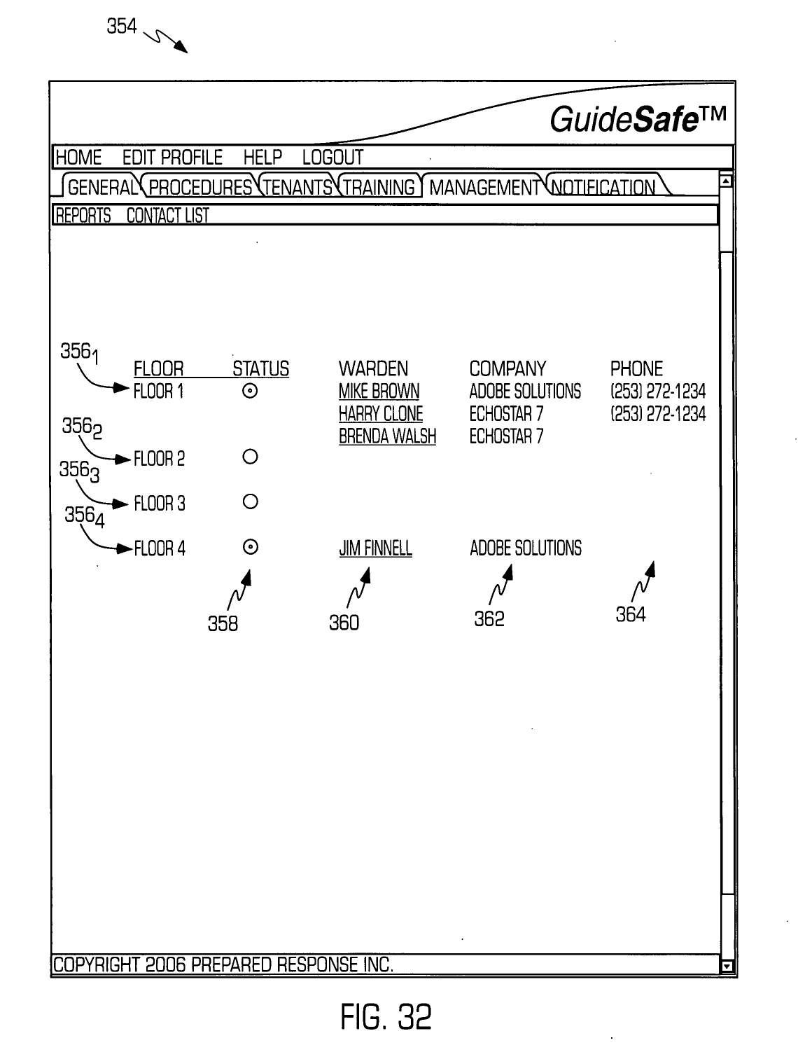

FIG. 32 illustrates an example of a building management user interface 354 for an example of the building safety system. In this user interface, a record 356 for each floor of a building (whose safety is managed by the building safety management system) is shown, such as records 356₁-356₄ for the four floor exemplary building. Each record contains the name for the floor, a status indicator 358 for each floor (indicating whether or not the particular floor is occupied), a floor warden field 360 that lists the Floor Warden for the particular floor (wherein there may be multiple floor wardens for a particular floor depending on the size of the floor and the number of different tenants resident on the floor), a company field 362 that lists the one or more companies that are resident on each floor of the building, and a phone field 364 that contains a phone number (if available) for the floor wardens shown in the user interface.

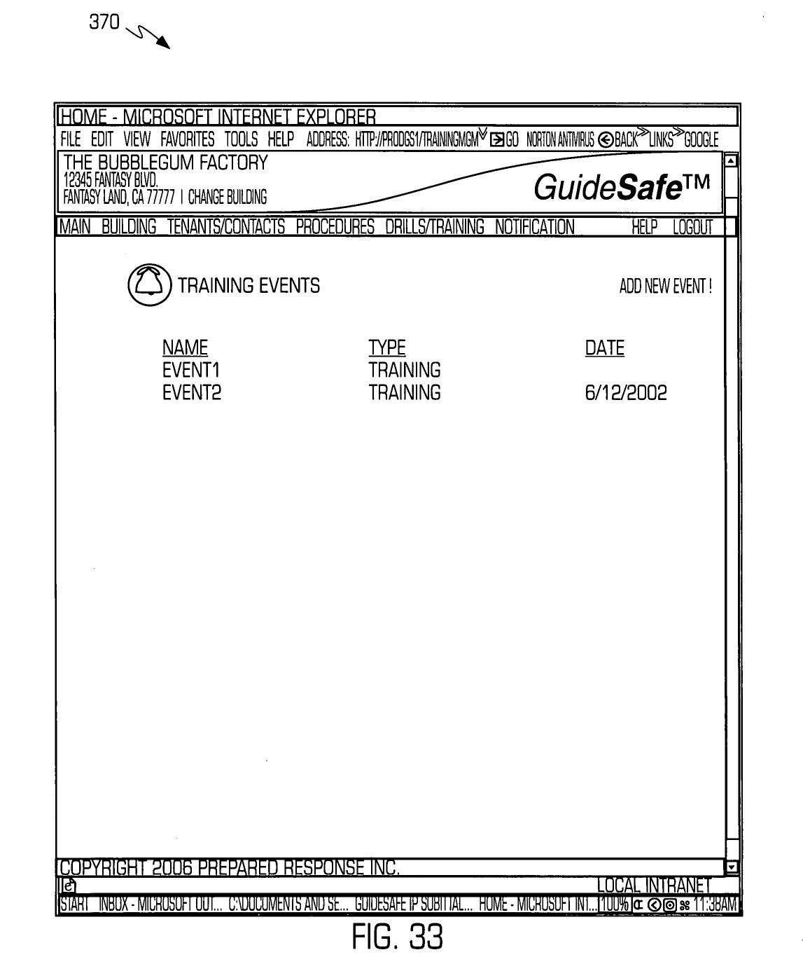

FIG. 33 illustrates an example of a building training events user interface 370 for an example of the building safety system. The user interface lists the one or more training events for the particular building and permits an authorized user to add a new training event. For each training event, the name of the training event is listed, the type of the training event and the date of the training event (if one has been assigned to the training event.)

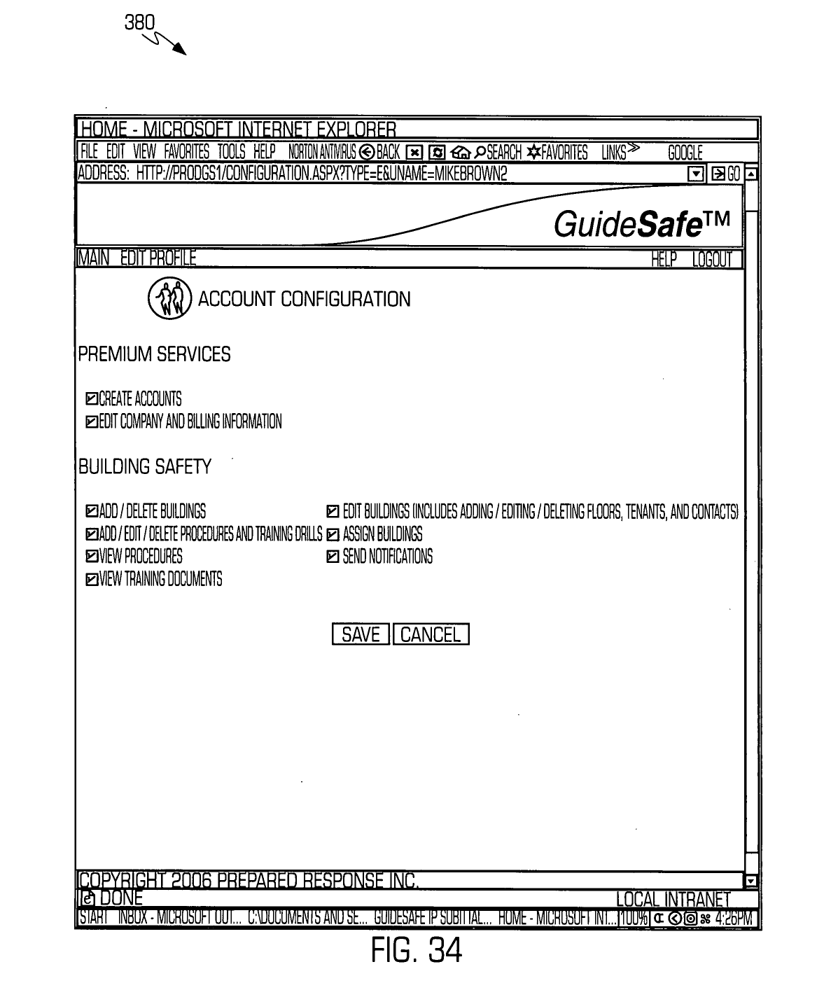

FIG. 34 illustrates an example of an account configuration user interface 380 for an example of the building safety system. The user interface permits an authorized user to configure a particular user account that includes premium services (to permit the user to create accounts and/or edit company and billing information if the boxes are checked in the user interface) and building safety services (to permit the user to add/delete building, add/delete/edit procedures and training drills, view procedures, view training documents, edit building information, assigning building and/or set up the sending of notifications if the boxes are checked in the user interface).

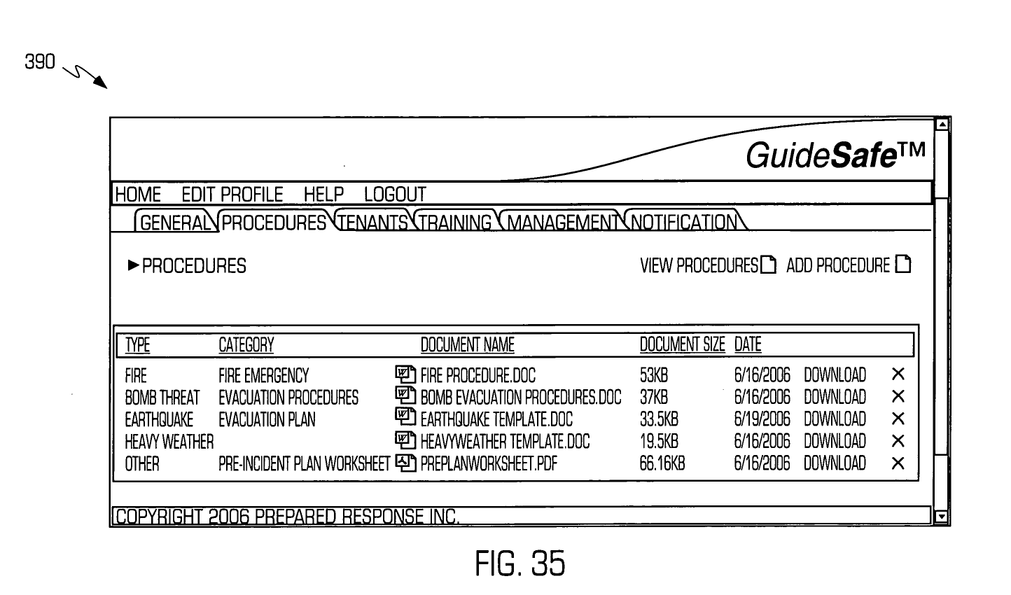

FIG. 35 illustrates an example of a building safety procedures user interface 390 for an example of the building safety system. This user interface permits user (who is authorized to view the procedures) to view the different procedures for the particular building and download those procedures. The user interface also permits an authorized user to add a new procedure.

The notification system described above consists of text that is created by an administrator of the building safety management system. The text is stored in the data base shown in FIG. 1 and the text describes event(s) scheduled to occur, provides awareness or review orders for updated procedures, or advises one or many nodes or devices of conditions or situations that require action. The notifications are transmitted in one or more formats that can be accommodated by SMPT email systems, SMS protocol for cell phones, translation to voice for audio systems such as phone, radio or building announcement.

The building safety management system may also include a novel building safety procedure access process and method that may be implemented as an access unit that is implemented with a plurality of lines of computer code. With this new access process, the occupants of a particular building may be assigned a common username and password wherein the common username and password is shared by all of the occupants of the particular building. With this common username and password, tracking the login and navigation of a username may not provide sufficient granularity to understand how many unique viewers (or at least computers) have logged into review a procedure. In order to obtain better visibility, the access unit of the building safety management system may capture the well known MAC address (which is unique for each user even when they use the common password and username) of each visitor. Using a composite of the MAC address and the username, an administrator can determine the number of unique visits to a particular procedure even with the common username and password. Using this process, an administrator can understand how many new visits to a location on the website may have transpired since a day. This is useful if the administrator revises a new procedure and needs to understand how many unique people have viewed the new guidance. If the unique visits indicate few of the building occupants have visited a new procedure, the manager can better take steps to develop awareness.

While the foregoing has been with reference to a particular embodiment of the invention, it will be appreciated by those skilled in the art that changes in this embodiment may be made without departing from the principles and spirit of the invention, the scope of which is defined by the appended claims.

1. A building safety management system, comprising:
a computer-implemented building safety management unit;
a secured communications link capable of being coupled to the computer-implemented building safety management unit that provides secure access to the computer-implemented building safety management unit;
one or more users, each using a computing device, to access the computer-implemented building safety management unit over the secured communications link, the one or more users further comprises one or more of a customer and an administrator; and
the computer-implemented building safety management unit further comprising a procedures unit having one or more lines of computer code that displays one or more building safety procedures to the one or more customers, a tenants unit having one or more lines of computer code that permits the one or more administrators to manage the tenants in each building managed using the building safety management system, a training unit having one or more lines of computer code that displays one or more training events to the one or more customers, a management unit having one or more lines of computer code that permits the one or more administrators to manage and modify one or more of the building safety procedures, the training events, the notifications and a set of building information, and a notification unit having one or more lines of computer code that generates a notification to one of the customer and the administrator of the system.

2. The system of claim 1, wherein the set of building information further comprises a building floor identification that consistently identified each floor of the building.

3. The system of claim 1, wherein the set of building information further comprises a floor warden assigned to one or more floors of the building based on the building safety procedures for the building.

4. The system of claim 1, wherein the training unit further comprises a training event pages that permits the one or more customers to view one or more training events associated with a building and permits the administrator to add new training events.

5. The system of claim 1, wherein the one or more building safety procedures further comprises one of a bomb procedure, a fire procedure, a water damage procedure, an earthquake procedure, a hazmat/chemical procedure, an intruder procedure, a riot procedure, a heavy weather procedure and a user defined procedure.

6. The system of claim 5, wherein the building safety procedures have one of a PowerPoint format, a PDF format, a word format and an image format.

7. The system of claim 1, wherein the secured communications link further comprises a secured Internet and a firewall, connected to the secured Internet, inside of the computer-implemented building safety management unit.

8. The system of claim 1, wherein the computer-implemented building safety management unit further comprises one or more server computers.

9. The system of claim 8, wherein the computer-implemented building safety management unit further comprises a web system with one or more web servers.

10. The system of claim 1 further comprising a data storage unit connected to the computer-implemented building safety management unit that stores the data associated with the computer-implemented building safety management unit.

11. The system of claim 10, wherein the data storage unit further comprises a primary database and a backup database.

12. The system of claim 11, wherein the primary database and the backup database further comprises a plurality of relational tables.

13. The system of claim 1, wherein the customer further comprises a building owner.

14. The system of claim 1, wherein the customer further comprises a management company and wherein the management company manages a plurality of building using the computer-implemented building safety management unit.

15. The system of claim 1, wherein the computer-implemented building safety management unit further comprises an access unit that monitors a number of unique visits to the computer-implemented building safety management unit by capturing the MAC address of each user when the user accesses the computer-implemented building safety management unit.

16. A building safety management method using a computer-implemented building safety management unit, a secured communications link capable of being coupled to the computer-implemented building safety management unit that provides secure access to the computer-implemented building safety management unit and one or more users, each using a computing device, to access the computer-implemented building safety management unit over the secured communications link, the one or more users further comprises one or more of a customer and an administrator, the method comprising:
displaying one or more building safety procedures to the one or more customers wherein the building safety procedures are stored in the computer-implemented building safety management unit;
managing one or more tenants in each building managed using the building safety management system;
displays one or more training events to the one or more customers wherein the training events are stored in the computer-implemented building safety management unit;
managing, by the administrators of the computer-implemented building safety management unit, one or more of the building safety procedures, the training events, the notifications and a set of building information; and
generates a notification to one of the customer and the administrator of the system.

17. The method of claim 16, wherein the set of building information further comprises a building floor identification that consistently identified each floor of the building.

18. The method of claim 16, wherein the set of building information further comprises a floor warden assigned to one or more floors of the building based on the building safety procedures for the building.

19. The method of claim 16, wherein the one or more building safety procedures further comprises one of a bomb procedure, a fire procedure, a water damage procedure, an earthquake procedure, a hazmat/chemical procedure, an intruder procedure, a riot procedure, a heavy weather procedure and a user defined procedure.

20. The method of claim 19, wherein the building safety procedures have one of a PowerPoint format, a PDF format, a word format and an image format.

21. The method of claim 16, wherein the customer further comprises a building owner.

22. The method of claim 16, wherein the customer further comprises a management company and wherein the management company manages a plurality of building using the computer-implemented building safety management unit.

23. The method of claim 16 further comprising monitoring a number of unique visits to the computer-implemented building safety management unit by capturing the MAC address of each user when the user accesses the computer-implemented building safety management unit.
